(19) United States
(12) Patent Application Publication
(10) Pub. No.: US 2011/0007178 A1
(43) Pub. Date: Jan. 13, 2011

(54) CORRECTION OF SPOT AREA IN MEASURING BRIGHTNESS OF SAMPLE IN BIOSENSING DEVICE

(75) Inventor: Josephus Arnoldus Henricus Maria Kahlman, Tilburg (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/919,513

(22) PCT Filed: Mar. 5, 2009
(86) PCT No.: PCT/IB09/50907

§ 371 Date: Aug. 26, 2010

(30) Foreign Application Priority Data
Mar. 12, 2008 (EP) 08102551.2

(51) Int. Cl. H04N 5/228

(52) U.S. Cl. 348/222.1; 348/E05.031

(57) ABSTRACT

A biosensing device for sensing brightness of a bio sample from frames of a video signal, has circuitry (40) arranged to receive the video signal and determine a brightness of a given area (110) of one or more of the frames in real time. A controller (50) adjusts boundaries of the given area, and uses the measures of brightness for different boundaries, to determine location of edges of the sample, then sets the boundaries according to the edges for subsequent measurements of brightness. By determining the brightness in real time, the given area can be adjusted in real time. By adjusting the given area based on real time assessments of brightness, various common errors or tolerances in sample shapes and locations can be compensated without the need for the software to carry out operations at pixel rates.

This invention relates to biosensing devices, to image processing devices, and to corresponding methods and software. In particular, the invention relates to such devices for sensing brightness of a sample from an area of a frame of video signal.

The ability to identify and/or separate biosamples such as cell sub-populations from a heterogeneous cell mixture is essential in many biomedical applications. Some methods exploit specific binding of antibodies to antigens on a cell surface to target a particular cell population. Examples of such methods are magnetically activated cell sorting (MACS), where antibody-functionalized magnetic beads are attached to the cells and sorted in a magnetic field, or fluorescence-activated cell sorting (FACS), where cells are labeled with fluorescent antibodies and separated by electrostatically deflecting charged liquid droplets containing the cells. Current FACS analyzers are very versatile instruments and allow cell separation on the basis of multiple simultaneous markers, cell size, and scattering properties. However, they are large and expensive instruments and can only be operated by trained personnel.

Recently, considerable effort has been put into transferring cell analysis to micro fabricated systems. The advantages of lab-on-a-chip devices include ease of use and low fabrication costs (ultimately leading to disposable chips), low fluid volumes and reagents consumption, large integration of functionalities, high-throughput analysis via massive parallellization and increased process control due to the faster response of the system.

A known lab-on-chip platform comprises a disposable cartridge and a benchtop-sized or even hand held control instrument and reader that manages the interface between the operator and the biochip. These are used for DNA analysis or for growing bacterial cultures amongst other applications. The cartridge contains or is formed by a bio-chip. The high degree of integration of the miniature lab helps reduce the level of manual intervention. A graphical user interface can be used to monitor the analysis in progress. The operator simply loads a DNA sample for analysis and inserts the cartridge into the instrument. All chemical reactions occur inside the biochip's proprietary buried channels or on its surface. Because the cartridge that carries the chip is self-contained and disposable, the system strongly reduces the cross-contamination risks of conventional multistep protocols.

The example of DNA analysis can use both DNA amplification, and a PCR (polymerase-chain-reaction) process for detection. A DNA sample is mixed with a polymerase enzyme and DNA primers and passed through a bank of micro channels in the chip, each measuring 150×200 microns, within the silicon. Electrical heating elements in the silicon—essentially resistors—heat the channels, cycling the mixture through three precise predetermined temperatures that amplify the DNA sample.

The system then uses MEMS actuators to push the amplified DNA into the biochip's detection area, which contains DNA fragments attached to the surface probe. There, matching DNA fragments in the sample, target DNA attach themselves to the fragments on the electrodes, whereas DNA fragments without matching patterns fall away. The system achieves accuracy by accurate temperature control. It detects the presence of the DNA fragments by illuminating them with a laser and observing which electrodes fluoresce.

Short chain ss-DNA complementary to DNA of various pathogens can be spotted on a substrate by printing, typically ink-jet printing. (An example is SurePrint technology made by Agilent, as shown at www.chem.agilent.com). Upon hybridisation with DNA fragments labelled with fluorophores, certain spots on the substrate will become emissive, evidence for the presence of pathogen DNA having bound to these respective spots.

In some cases it is useful to detect relative increases and decreases in the amount of a sample over time, in which case a video camera and image processing software can be used. As DNA microchips are now well established, the research focus is rapidly shifting to the analysis of proteins and even more complex biological systems, such as living cells.

This could be useful for applications such as biosensors for e.g. road-side drugs of abuse testing in saliva. Drugs of abuse are generally small molecules that only possess one epitope and for this reason cannot be detected by a sandwich assay. A competitive or inhibition assay is the method to detect these molecules. A well-known competitive assay setup is to couple the target molecules of interest onto a surface, and link antibodies to a detection tag (enzyme/fluorophore/magnetic bead). This system is used to perform a competitive assay between the target molecules from the sample and the target molecules on the surface, using the tagged antibodies.

It is known to use image analysis software to detect changes in brightness of spots of material under test. This can involve analysing video frames captured in a frame buffer from video signals generated by a video camera. Such image analysis is not suitable for road side use or other instant tests, as it typically involves time consuming and processor intensive and memory intensive image processing.

### SUMMARY OF THE INVENTION

An object of the invention is to provide improved biosensing devices, devices for sensing brightness of a sample from an area of a frame of video signal, image processing devices, and/or corresponding methods and software.

According to a first aspect, the invention provides:

A biosensing device for sensing brightness of a sample from frames of a video signal of the sample, the biosensing device comprising:

circuitry arranged to receive the video signal and determine a value of a parameter related to a brightness of an area of one or more of the frames in real time, and a controller coupled to the circuitry to adjust boundaries of the area for the circuitry, and use the determined values of the parameter related to brightness for different boundaries to determine a location of one or more edges of the sample, the controller being arranged to set the boundaries according to the edges for subsequent measurements of brightness by the circuitry.

A means for generating the video signal such as an imaging device such as a CCD or CMOS camera, or an array of distinct photo diodes can be provided. The area can be an active pixel area in which a value related to brightness, e.g. an average is calculated. By determining the brightness in real time, the area can be adjusted in real time. By adjusting the area based on real time assessments of brightness, various common errors or tolerances in sample shapes and locations can be compensated without the need for the controller to carry out operations at pixel rates. Hence it can reduce processing and storage requirements compared to known methods involving storing many frames for later off-line processing. Real time can encompass within one or two frame periods. Brightness can represent any of many different properties of the sample such as degrees of contrast, reflectivity, transmissivity, evanescent field, fluorescence, polarization, colour hue, colour saturation, texture or other characteristic that can be obtained from the video signal of the sample, whether the sample is back lit or front lit, and can be with respect to human visible or other than visible wavelengths. It can be in absolute terms or relative to a reference such as a background. Measure is preferably compared to a “reference-level” to suppress common mode signals, but the invention is not limited hereto.

Embodiments within this aspect of the invention can have any additional features, and some such additional features are set out in dependent claims, and some are set out in the examples in the detailed description.

One such additional feature is the controller being arranged to determine the location of the edge by determining a change in a relationship of brightness to area as one or more of the boundaries are changed. This can be achieved by an image filter such as a contrast filter or a High Pass Filter to detect brightness changes.

Another such additional feature is the controller being arranged to deduce other locations of other edges of the sample from the location of the edge, and to set the boundaries of the given area according to the locations.

Another such additional feature is the controller being arranged to set boundaries in the form of vertical and horizontal lines represented by row and column start and end points, and the circuitry being arranged to determine the brightness from values of pixels within the those lines within the frame.

Another such additional feature is the controller being arranged to determine a shape of the sample by setting the given area to be smaller than the sample, moving the given area across the sample and deducing the shape from changes in the measured brightness of the given area as the given area is moved.

Another such additional feature is the controller being arranged to deduce a corrected brightness value for the sample from the measured brightness indication for the given area, to compensate for differences between a known shape of the given area, and a shape assumed for the sample.

Another such additional feature is the circuitry having an integrator coupled to receive the video signal to determine the brightness.

Another such feature is the circuitry comprising a line counter and a pixel counter, and comparators to compare the outputs of these counters to the row and column start and end points, outputs of the comparators being coupled to the integrator to enable it to integrate only pixel values inside the boundaries and to reset the integrator value. Another such feature is the device being incorporated in a handheld reader for receiving cartridges having many of the samples, e.g. biosamples.

Another aspect of the invention provides an image processing device for determining brightness of a sample, the device having circuitry arranged to receive a video signal and to determine values of a parameter related to brightness of a given area of one or more frames of the video in real time, and a controller coupled to the circuitry to adjust boundaries of the given area for the circuitry, and use the measures of the parameter related to brightness for different boundaries, to determine location of one or more edges of the sample, the controller being arranged to set the boundaries according to the edges for subsequent measurements of brightness by the circuitry, and the controller being arranged to deduce a corrected brightness value for the sample from the measured brightness, to compensate for differences between a known shape of the given area, and a shape assumed for the sample.

Other aspects of the invention include corresponding methods of biosensing, of image processing, of manufacturing devices for biosensing or for image processing. Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

How the present invention may be put into effect will now be described by way of example with reference to the appended drawings, in which:

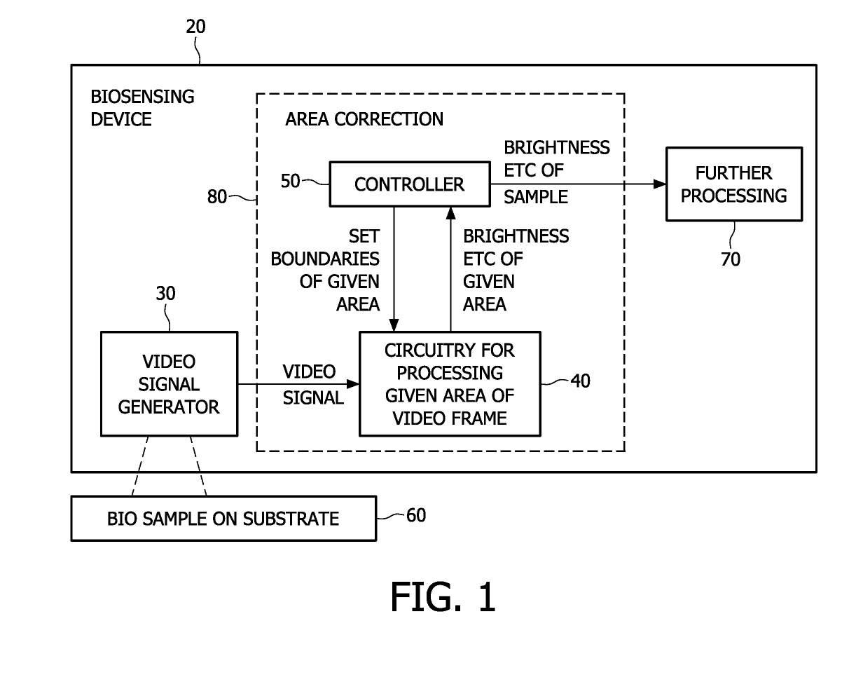

FIG. 1 shows a bio sensing device according to a first embodiment,

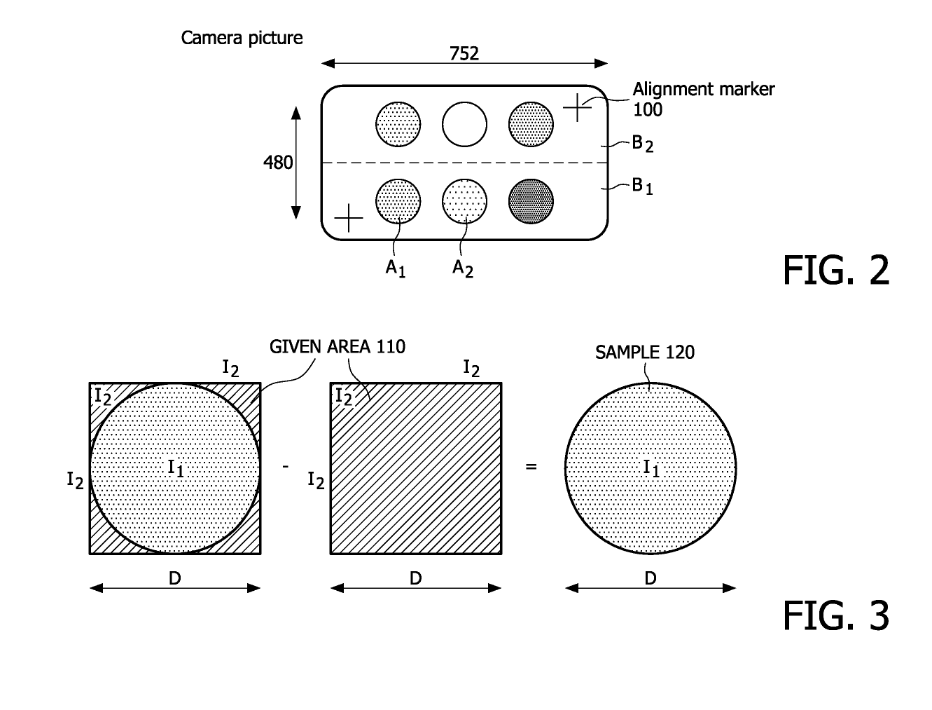

FIG. 2 shows a view of a frame of video from a camera showing a number of biosamples on a substrate,

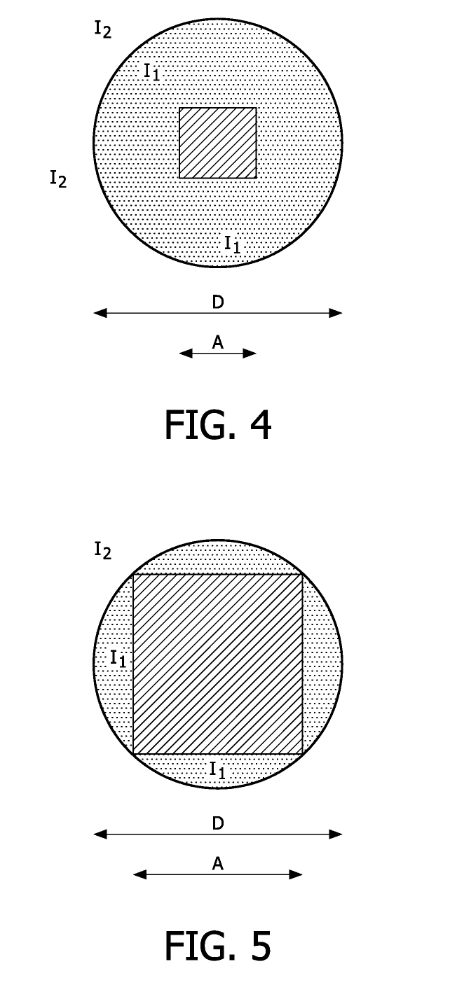

FIGS. 3 to 10 show views of a given area and the sample,

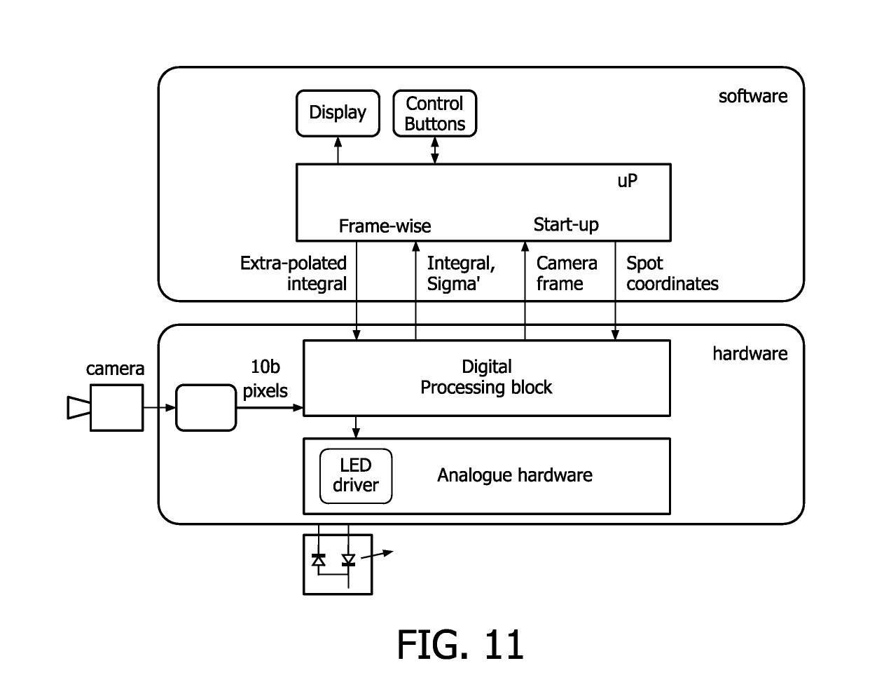

FIG. 11 shows an example of an arrangement of hardware and software for area correction according to an embodiment,

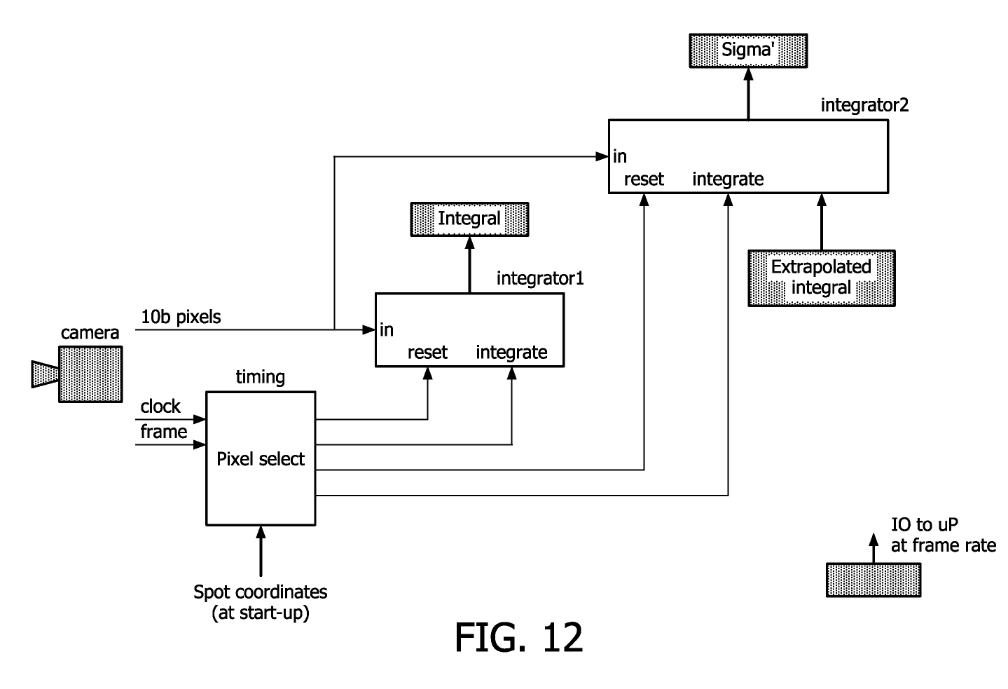

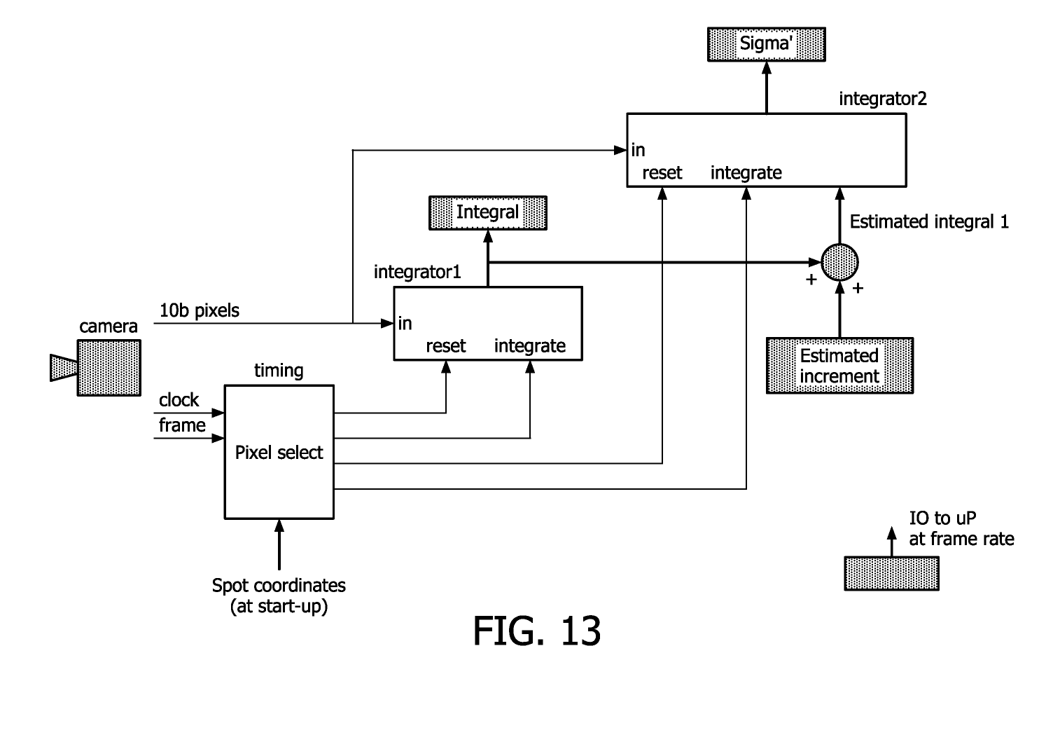

FIGS. 12 and 13 show examples of layouts of the circuitry for processing the video signal according to an embodiment, and

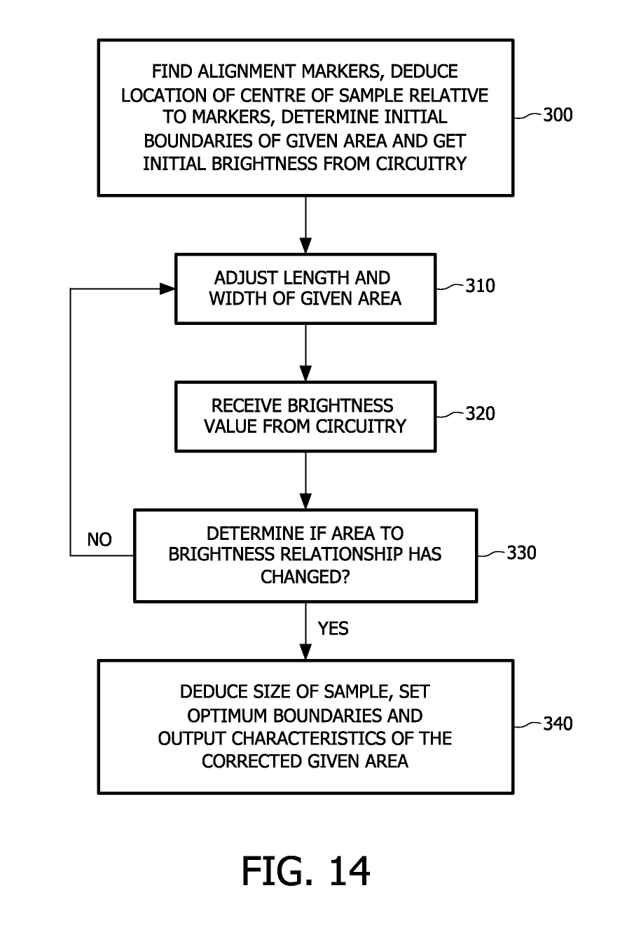

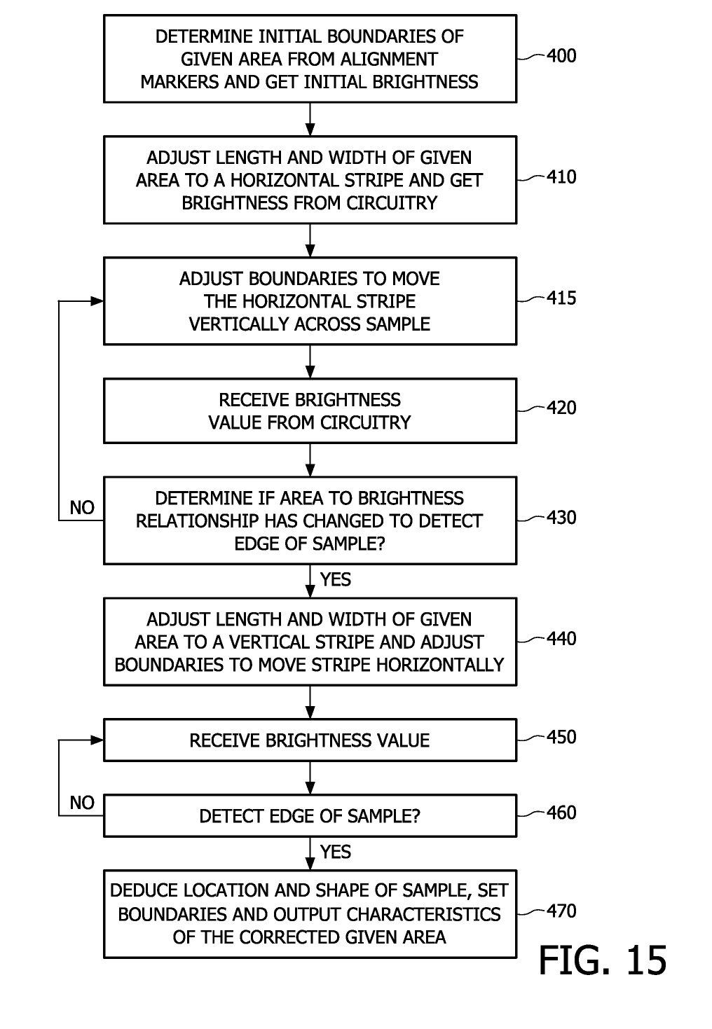

FIGS. 14 and 15 show examples of operations of the controller according to an embodiment.

### DESCRIPTION OF THE PREFERRED EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein. Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination. Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description. By way of introduction to the embodiments, some problems or disadvantages addressed by some of the embodiments will be discussed.

For some applications such as road-side testing, the assay should be fast (˜1 min) and robust. An imaging device, e.g. a detector or camera such as a CMOS or CCD (charge coupled detector) device can be used to image the reflected light and observe assay events such as the binding on the applied binding-spots on the surface of the substrate (such as a glass plate, swab or cartridge).

Due to fabrication errors or distortion in the optical imaging system (e.g. pillow-shaped distortion) the position and the shape of assay locations such as binding spots with respect to alignment markers may differ from that expected. Furthermore the dimensions of an assay location such as a binding spot may change due to production (e.g. spotting) tolerances or tolerances in the light path. As a result measuring errors will occur, which will become clear first after or during the assay. To correct these later off-line would mean storing a lot of video frames in order to be able to trace back the assay and correct the errors, which is not practical.

Assay locations such as binding spots are optionally circular/elliptical shaped, but circle-shaped given areas can cause extra hardware complexity and power consumption in the digital processor.

Some advantages of the present invention related to the compensation of these errors are practical constraints such as:
1. fast acquisition
2. good accuracy
3. avoiding frame memory, avoiding hardware complexity
4. low power consumption
5. low computational power such as low-cost micro controller
6. flexible architecture

### FIG. 1, A First Embodiment of a Biosensing Device

A first embodiment of the present invention is shown in FIG. 1. This shows a schematic view of a biosensing device 20 having a video signal generator 30 arranged to image a biosample 60 on a substrate. The video signal generator may be part of the biosensing device or it may be a separate apparatus for use with the biosensing device 20. The substrate can optionally be incorporated within the biosensing device, or be a separate cartridge or swab or any container for example.

An area correction part 80 of the device takes the video signal and has circuitry 40 for processing a given first area of each frame of video. For some applications a time sequence of brightness values is needed in order to interpret an assay event such as a chemical binding process correctly for example. In one embodiment, at least 10 frames per second should be processed, e.g. from a 752H×480V (CCD/CMOS) video camera. The circuitry outputs a brightness value of a given first area, and may output other values such as a noise level. More details of examples of how to implement such circuitry are described below with reference to FIGS. 12 and 13. The circuitry receives control signals from a controller 50 to set boundaries of the given first area. This can be in the form of explicit boundaries or indirect information such as corners or centre and size information, enabling the first area to be defined.

The controller is arranged to adjust boundaries of the given first area for the circuitry, and to use the measures of brightness from the circuitry, for different boundaries, to determine location of one or more edges of the sample. Then the controller can set the boundaries according to the edges for subsequent measurements of brightness by the circuitry.

This can be carried out during or after the assay, or even as a preliminary step, if the location of the assay locations, e.g. spots can have a distinct brightness. Thus the controller can align the position and the dimensions of the given first areas with the assay locations such as binding spots based on the observed light intensity in said first areas. After the optimal position is achieved, the measured assay event intensity values such as the binding spot intensities can in some embodiments be corrected in accordance with a dimensional parameter such as a position-, shape and/or dimension deviation at any or each moment in time.

It is preferred to use an optimal shape and position for the first areas, which can be optimised by using the light intensity.

The controller can correct afterwards the intensities when the shape and position were in fact not optimal, e.g. at the start of the assay when the bindings are not yet visible. This is more accurate as deviations are smaller.

Rectangular (square) shaped predetermined first areas or other shapes such as polygonal areas can be used optionally, e.g. to limit the hardware-complexity and/or the power consumption if desired although shapes requiring more complex calculations can be used, e.g. circles. The measured intensities can be corrected for the shape of the assay locations such as binding-spots if appropriate, e.g. for the circular or other shaped areas. In some embodiments, the video camera is connected to circuitry 40 in the form of a digital processing block (e.g. implemented as a Field Programmable Gate Array FPGA) to calculate during every video frame the average light intensity E{xᵢ} in a multitude of predetermined first areas corresponding with the alignment marker(s) on the cartridge. The digital processor block can be coupled to the controller in the form of a general purpose processor running software, e.g. a microprocessor or microcontroller. Such software can have, i.e. has suitable code to execute, a function of determining brightness and other features such as noise level, of the sample as shown in FIG. 1. Other functions of such software, i.e. code for execution of the functions, are represented in FIG. 1 by the further processing box 70. In a particular embodiment, some of the main functions of such software are as follows:
1. Collect frame-wise the integrals E{xᵢ} in the predetermined first areas corresponding to alignment markers on the substrate e.g. in a cartridge.
2. Optimise via an iterative process said integrals by controlling the position of the predetermined first areas during consecutive video frames.
3. Calculate, when the optimisation has finished, the coordinates of predetermined first areas corresponding with the assay locations such as binding-spots and start detection as described in more detail below.
4. During or after the measurement, the position, shape and/or dimensions of the assay locations such as binding spots is/are measured and used to correct the position and dimension of the predetermined first areas for subsequent brightness measurements, i.e. to determine second areas or to correct the already obtained measurements.

Other characteristics of the image of the sample can also be determined, such as noise (sigma) measurements as described below in more detail.

Compared to known methods, this approach can offer at least one of the following advantages:
1. faster alignment procedure
2. low speed micro-controller can be used for the calculations, as all communication can be on a frame rate basis following calculation of brightness values.
3. good fit with the processing of the image acquisition device such as a camera for the assay locations, e.g. binding-spots.
4. high throughput, high frame-rates achievable
5. low power consumption
6. low complexity (no frame-memories)
7. flexibility

This approach offers a good balance between hardware and software processing.

### FIG. 2, Frame View

FIG. 2 shows an example of a frame of the video signal from the camera, comprising immobilized beads on an assay location, e.g. binding spot Aₙ in a surrounding white-area Bₙ.

This picture is obtained by (predominantly) homogeneous illumination of the FTIR surface and projection of the reflected light via an optical system onto a camera, e.g. CMOS or CCD camera.

The relative darkening D of an assay location, e.g. binding-spot compared to the surrounding white-area is a quantitative assay measure, e.g. a measure for the number of bindings. Alignment markers define the position of the assay locations, e.g. binding-spots.

### FIG. 3 Embodiment 1: Correction for Binding-Spot Shape

To reduce hardware complexity and power consumption, the assay locations, e.g. binding spots are measured by a suitable method, e.g. finding the brightness of a polygonal, e.g. rectangular given first area 110 (intensity I2) centred on the assay location, e.g. the spot (intensity I1) as shown in FIG. 3. As the assay locations, e.g. binding-spots are usually not rectangular, the measured light power of the rectangular first area does not reflect the correct information.

FIG. 3 shows a circular assay location, e.g. binding spot (dark shaded, intensity I1) from which the intensity is measured by measuring a polygonal e.g. rectangular given first area (diagonal shaded, intensity I2). As shown diagrammatically, in FIG. 3, the brightness of the assay location, e.g. spot in terms of the average light intensity can be found by subtracting the measurement of the same first area without the assay location, e.g. spot, from the measurement of the given area containing the spot.

Inside and outside the assay location, e.g. binding spot the average light intensities are I₁ and I₂ respectively. During or after the assay event, e.g. binding, the measured light power is equal to

$${P}_{spot} = {I}_{2} ( 1 - \frac{π}{4} ) {D}^{2} + {I}_{1} \frac{π}{4} {D}^{2} .$$

The average light intensity outside the assay location, e.g. binding spot (“white spot”) is P_{white}=I₂D².

This value can be obtained from an area without beads, e.g. outside the assay locations, e.g. binding spots, as well as from measuring the assay location, e.g. binding spot-area before binding takes place (and beads washed away).

During or after the binding takes place, Pₛₚₒₜ is corrected according to

$${P}_{spot , corr} = {P}_{spot} - ( 1 - \frac{π}{4} ) {P}_{white} = {I}_{1} \frac{π}{4} {D}^{2} ,$$

which corresponds to the light power in the circular binding-spot.

Note that this method can also be applied to any known shape of the assay location, e.g. binding spot. An example of how to obtain the binding spot shape, will be discussed below.

### FIGS. 4-7 Embodiment 2: Adapting to Binding-Spot Dimensions

The size of the assay locations, e.g. binding spots may differ due to spotting-tolerances or just by intended (spotting) process changes. Furthermore dimensions may differ from the expected due to optical light path tolerances or distortions.

FIGS. 4 to 7 show a circular binding spot whose intensity is measured by a rectangular predetermined area for four situations.

For FIG. 4,

$$A \leq \frac{D}{\sqrt{2}}$$

The light power is P=I₁A², hence proportional to the predetermined area surface.

For FIG. 5,

$$A = \frac{D}{\sqrt{2}}$$

P=I₁A²

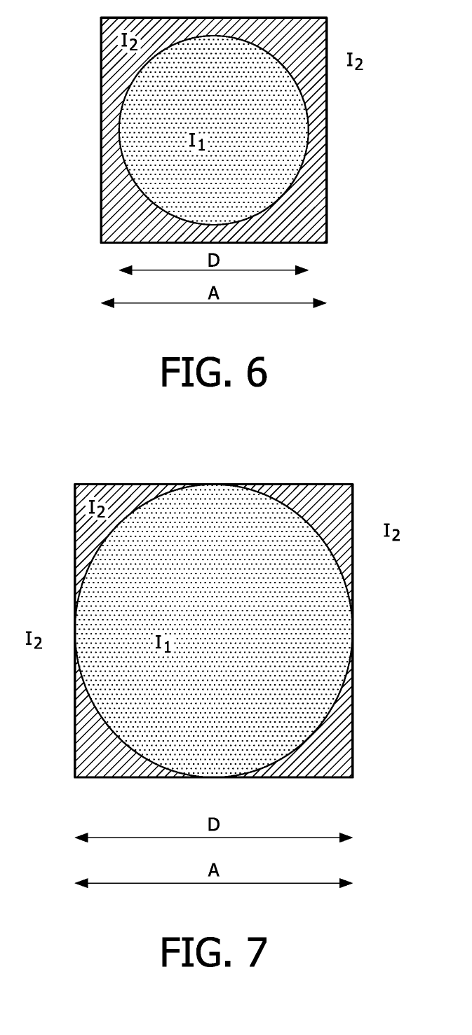

For FIG. 6, A≧D

Then the predetermined area is too large and

$$P = {I}_{2} ( {A}^{2} - \frac{π}{4} {D}^{2} ) {I}_{1} \frac{π}{4} {D}^{2} .$$

For FIG. 7, A=D

This is the desired situation, the light power

$$P = {I}_{2} ( 1 - \frac{π}{4} ) {A}^{2} + {I}_{1} \frac{π}{4} {A}^{2} ,$$

which can be found by optimising the light power P when varying A.

For example, firstly the situation of FIG. 5 is accomplished by increasing A until the dependency of P to A deviates from the pure quadratic behaviour. Then the situation of FIG. 7 can be achieved by substituting D=\sqrt{2}A

The situation of FIG. 5 can also be considered as optimal. Then the correcting method as mentioned in embodiment 1 can be used.

Note that this embodiment can also be used for finding the shape of the assay location, e.g. binding-spot. Then the width- and the length of the predetermined area are varied until the light power is optimised.

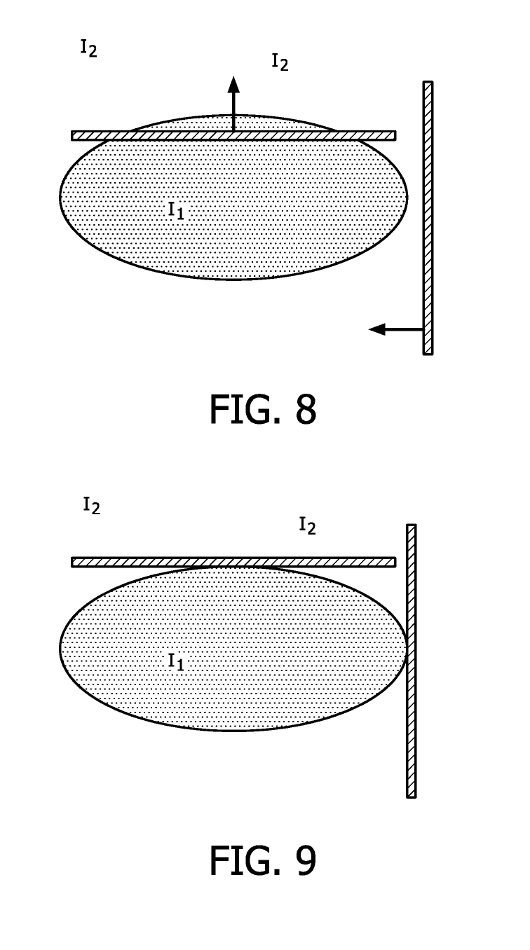

### FIGS. 8-10 Embodiment 3: Adapt to Binding Spot Position and Shape

The spot shape (geometry) may differ from the (ideal) circular shape because of tolerances in the spotting process. The spot-shape, and also the spot-position can be determined by moving long (e.g. line shaped) predetermined areas across the binding spots and looking for intensity changes. FIG. 8 shows schematically an elliptical spot shape, with a horizontal long thin given first area being moved vertically across the spot in sequential frames. Subsequently the given first area is changed to a thin vertical area, and is moved horizontally across the spot. In principle, more than one given first area could be swept simultaneously. While thin given first areas are suitable for sweeping to find boundaries if the given first area is to be rectangular, if a more complex shape is chosen, the shape for sweeping could be a small rectangular which is scanned line by line.

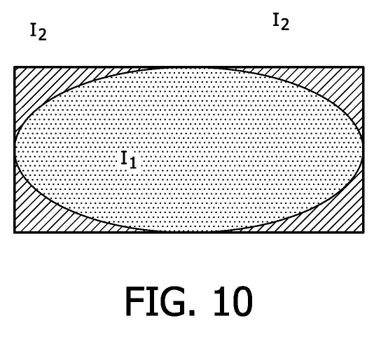

FIG. 9 shows where the vertical and horizontal given first areas have reached the edges of the spot. This can be detected by sensing that further movement away from the spot gives no further change in brightness of the given first area. Alternatively the shape can be determined by optimizing the dimensions and position of a rectangular area until the “borders” of the spot are detected.

After acquiring the shape, the given first area is set accordingly. FIG. 10 shows the given first area set to match the boundaries of the elliptical spot to provide correction of errors in location and shape.

The present invention includes several variations, such as:
1. Combining location, shape and compensation in one assay measurement.
2. Use for other shapes, not limited to circular or ellipsoid binding-spot shapes
3. The number of pixels (area) used in a pre-determined area may be varied to ease acquisition and overcome mechanical tolerances. E.g. at the start, a relatively large first area is used to make sure that the alignment marker is inside the pre-determined first area. After reasonable acquisition has achieved, the first area may be decreased, e.g. to a second area to optimise the SNR of the control loop.
4. Other geometries may be used, e.g. to generate push-pull and sum-signals for fast acquisition.
5. The same methods can be applied to compensate for the “noise” measurements as described below.

The digital processing block (e.g. a Field Programmable Gate Array FPGA) can calculate during every video frame not only the average light intensity E{xᵢ} but also the quality (noise) σ′ in a multitude of given areas of the frame. Said digital processor block is communicating with the software, e.g. in a microprocessor or microcontroller, which:
1. Is adapted to calculate at start-up (after inserting the cartridge) the coordinates of the active pixels in said predetermined areas in a video frame and write said coordinates to the digital processor block.
2. Is adapted to collect frame-wise the integrals E{xᵢ} and qualities σ′ in each of said predetermined first areas from the digital processor block.
3. Is adapted, for each of the predetermined first areas, to interpret the average signal as a function of time and submits an extrapolated integral value Ê{xᵢ} for the next frame (based on previous frames) to the digital processor block to be used for quality measurement.

This approach offers an optimal balance between hardware and software processing.

### FIG. 11 Example Architecture

FIG. 11 shows an example of an implementation of an architecture for running the software of the controller 50 and hardware for the circuitry 40 of a biosensing device in the form of a reader device.

The software side for implementing the controller functions comprises software run on a low cost processor having outputs to a display and user inputs in the form of control buttons. The circuitry 40 is implemented in the form of a digital processing block coupled to the camera and to the software application (e g running on a microprocessor or microcontroller). The digital processing block sends a value of a parameter relating to brightness measurements, e.g. in the form of an integral signal value once per frame to the software. The software returns an extrapolated integral each frame, and boundaries of the given first area in the form of spot coordinates. These can be in the form of corner coordinates of the given first area for example. A full frame of video can be sent to the software at the outset. At start-up (e.g. after the cartridge is inserted) the software calculates the coordinates of each of the assay locations, e.g. binding-spots and white-areas based on the obtained video frame, and writes these values to the digital processing block. Note that this can be performed by a low-speed microprocessor, as there is no need for real time calculation per pixel time, or line time, only per frame calculations.

FIG. 11 also shows analogue hardware in the form of a LED driver and LEDs for illuminating the sample. Other implementations are included within the scope of the present invention. Furthermore, an interface box is shown between the camera and the digital processing block. This can include for example ADC circuitry to output in this example 10 bit samples to represent each pixel digitally. Other implementations are also included within the scope of the present invention.

### FIGS. 12, 13 Digital Processing for One Binding-Spot/White Area

FIGS. 12 and 13 show examples of implementation of the circuitry 40 which may be used in the digital processing block of FIG. 11 or in other embodiments.

From a camera pixel clock and the frame synchronisation, the timing means in the processor determine which pixels have to be included in the measurement by controlling the “reset” (at the beginning of a frame) and the “integrate” (during active pixels) operation mode of the integrators.

The video signal in digital form is fed to Integrator 1 which determines the integral of the pixel values in a predetermined first area during a video frame according to

$$E \{ {x}_{i} \} = {2}^{- m} {\sum }_{spot} {x}_{i} .$$

Integrator 1 receives reset and integrate signals from a timing device which generates these signals, e.g. using counters and comparators and inputs representing the boundaries of the given first area in the form of spot coordinates. The counters produce coordinates of the current pixel based on pixel clock and line or frame clock inputs. These coordinates can be compared to the X and Y coordinates of the given first area and the integrating action can be activated only when the current pixel is within the first area.

Integrator 2 determines the integral of the absolute noise during a video frame according to

$${σ}^{′} = {2}^{- m} {\sum }_{spot} \vert {x}_{i} - \hat{E} \{ {x}_{i} \} \vert .$$

Here Ê{xᵢ} is the extrapolated Integrator 1 value per pixel, which is calculated from previous frames by the software, not necessarily from the last video frame. Integrator 2 also receives the video signal and timing signals reset and integrate from the timing part.

No further attempt need be made to calculate the exact average values, as this can easily be performed in the software and would only cost needless complexity and power consumption. Obviously, the hardware can calculate the real standard deviation, at the cost of complexity and power consumption if required.

The results are communicated on a low-frequency frame rate (30 frames/s) with the software. When a frame is finished the values are stored in so-called “Shadow registers” in order to set no unrealistic demands on communication speed. In this way frames rates up to 60 Hz can be achieved, without setting large demands on the processing. This architecture offers a useful balance between hardware and software processing.

Alternatively, as shown in FIG. 13, the software may estimate the slope (increment per frame) of Integrator 1 over time, and writes this to the digital processor. This approach can be beneficial because there is no need to read, process and write data between two video frames.

At the end of a video frame the estimated slope is added to the value output of Integrator 1, divided by the number of pixels in the first area (not shown) and used as the estimated Integrator 1 value per pixel for the next frame.

### FIGS. 14, 15 Overview of Controller Functions

FIG. 14 shows steps of controller functions according to an embodiment of the invention using only correction for size, rather than location and shape, as follows. Step 300 involves finding alignment markers in the video frame from the camera, and deducing sample spot location relative to markers. The initial boundaries of the given first area can be deduced and output to the circuitry. The circuitry returns a brightness value at the end of the frame.

At step 310, the iterative process of adjusting the given first area begins by adjusting length and or width values. The corresponding brightness value is received at step 320. At step 330, it is determined if the area to brightness relationship has changed, to determine if an edge (or perhaps a centre) of the given first area has been reached. If not the iteration is continued by repeating steps 310 to 330. If yes, at step 340 the size of the sample can be deduced, optimum boundaries of the given first area can be set and measurements made, to enable characteristics of the corrected given area (i.e. the second area) to be output.

FIG. 15 shows an alternative embodiment involving correction for shape and location. At step 400, initial boundaries are determined starting by finding alignment markers in the frame from the camera, and deducing sample spot location relative to markers. The initial boundaries of the given first area can then be deduced and output to the circuitry. The circuitry returns a brightness value at the end of the frame. At step 410 the controller adjusts the length and width of given first area to a horizontal stripe and gets a value of brightness from the circuitry.

Step 415 involves adjusting the boundaries to move the horizontal stripe vertically across the sample in the frame, as shown in FIGS. 8 and 9. After each movement, at the end of the frame a brightness value is received from the circuitry at step 420. Using the new brightness value, it is determined at step 430 if the area to brightness relationship has changed to detect an edge of the sample. If not, the iteration is continued by repeating steps 415 to 430. If yes, at step 450, the length and width of the given first area are adjusted to a vertical stripe and in successive frames the boundaries are adjusted to move the stripe horizontally. As before, at each frame a brightness value is received at step 450 and used to detect an edge of the sample at step 460. If not detected, steps 450 and 460 are repeated. If detected, the location and shape of sample can be deduced at step 470, boundaries of the given first area set to correspond to the second area, measurements made on the corrected second area, and a more accurate brightness value calculated from the measurements as set out above, and characteristics of the corrected given second area can be output.

Other ways of scanning the sample to determine the edges and thus determine errors in the location and shape of the spot are included within the scope of the present invention.

### Applications, Alternatives

Clearly these techniques set out above can be used in a wide variety of applications. For example for a magnetic biosensor, the detection tag can be a superparamagnetic particle. The magnetic particle (MP) is used both for detection as well as for actuation (attraction of the MP's to the surface to speed up the binding process and magnetic washing to remove the unbound beads).

The imaging of the sample can be arranged to make use of the principle of frustrated total internal reflection to sensitively detect magnetic particles on a surface of the substrate.

In an alternative embodiment, the biosensing device can have the substrate incorporated in which case it can have microfluidic components such as channels, valves, pumps, mixing chambers and so on. There can be an array of samples imaged by a single camera or an array of cameras in principle. These can be integrated with other parts and realized using active matrix technology or other integrated photo detector technologies, to suit the sensitivity needed for the application, or to suit other considerations such as cost, speed of detection, ruggedness and so on. The camera can be implemented integrated in an active plate comprising both n- and p-type TFTs. This can be part of a basic array comprising an active matrix (a-Si:H or Low Temperature Poly Silicon for example) of addressing transistors and storage capacitors in conjunction with a photo detector. The capacitor allows the light to be integrated over a long frame period time period and then read out. This also allows other circuitry to be added (such as the integration of the drive, charge integration, and read-out circuitry). The photo detectors can simply be TFTs, (Thin Film Transistors) which are gate-biased in the off-state, or lateral diodes made in the same thin semiconductor film as the TFTs, or vertical diodes formed from a second, thicker, semiconductor layer. If TFTs or lateral diodes are to be used as the photo detectors, then these come at no extra cost. However, for good sensitivity vertical a-Si:H NIP diodes can be used, and these need to be integrated into the addressing TFTs and circuitry. Such a scheme has already been implemented both in a-Si:H TFT technology.

Such an integrated device can be implemented using LAE (large area electronics) such as poly-Si or a-Si technology on glass. Traditional large area electronics (LAE) technology offers electronic functions on glass which is cheap substrate and has the advantage for optical detection of being transparent. Standard LAE technology can be used integrating (at little or no extra costs) photo-diode or photo-TFT detectors together with the usual addressing TFTs and circuitry.

The spots for attracting the biosamples can be placed by any suitable method, e.g. by ink-jet printing of liquid which is then dried. The samples can be DNA fragments/olignonucleotides, or any of a wide range of other bioware for other applications. The bioware (DNA-fragments) can be aligned with the photo detectors by having two regions next to each other, a hydrophobic and a hydrophyllic region. When the ink is printed it automatically pulls itself over the hydrophyllic region, and then dries in alignment with this location.

The device can be used for DNA analysis for example by exposing a dried spot of the bioware sample to an unknown sample containing DNA. If the DNA is complementary DNA, hybridisation occurs and the sample becomes fluorescent when illuminated. This can be detected by the photodiode and used to confirm the presence of the given complementary type of DNA. Of course other applications can be envisaged, and other types of photo detector can be used. The exposing of the sample can be carried out manually or can be automated by means of MEMS devices for driving fluids along microchannels into and out of the site. If needed, the temperature of the fluids and the site can be controlled precisely by resistors.

Other applications for the devices can include any type of luminescence assays, including intensity, polarization, and luminescence lifetime. Such assays may be used to characterize cell-substrate contact regions, surface binding equilibria, surface orientation distributions, surface diffusion coefficients, and surface binding kinetic rates, among others. Such assays also may be used to look at proteins, including enzymes such as proteases, kinases, and phosphatases, as well as nucleic acids, including nucleic acids having polymorphisms such as single nucleotide polymorphisms (SNPs), ligand binding assays based on targets (molecules or living cells) situated at a surface. Other examples include functional assays on living cells at a surface, such as reporter-gene assays and assays for signal-transduction species such as intracellular calcium ion. Still other examples include enzyme assays, particularly where the enzyme acts on a surface-bound or immobilized species.

The present invention also includes a computer program product which provides the functionality of any of the methods according to the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non-volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

It is to be understood that although preferred embodiments, specific constructions and configurations, as well as materials, have been discussed herein for devices according to the present invention, various changes or modifications in form and detail may be made without departing from the scope of this invention as defined by the appended claims.

1. A biosensing device for sensing brightness of a sample from frames of a video signal of the sample, the biosensing device comprising:
circuitry (40) arranged to receive the video signal and determine a value of a parameter related to brightness of an area (110) of one or more of the frames in real time, and
a controller (50) coupled to the circuitry to adjust boundaries of the given area for the circuitry, and to use determined values of the parameter related to brightness for different boundaries to determine a location of one or more edges of the sample, the controller being arranged to set the boundaries according to the edges for subsequent measurements of brightness by the circuitry.

2. The device of claim 1, the controller being arranged to determine the location of the one or more edges by determining a change in a relationship of brightness to area as one or more of the boundaries are changed.

3. The device of claim 2, the controller being arranged to deduce other locations of other edges of the sample from the location of the edge, and to set the boundaries of the area (110) according to the locations.

4. The device of claim 1, the controller being arranged to set boundaries in the form of vertical and horizontal lines represented by row and column start and end points, and the circuitry being arranged to determine a value of the parameter related to brightness from intensity values of pixels within the those lines within the frame.

5. The device of claim 1, the controller being arranged to determine a shape of the sample by setting the area (110) to be smaller than the sample, moving the given area across the sample and deducing the shape from changes in measured values of the parameter related to brightness of the area (110) as the area (110) is moved.

6. The device of claim 1, the controller being arranged to deduce a corrected brightness value for the sample from a measured brightness indication for the area (110), by compensating for differences between a known shape of the area (110), and a shape assumed for the sample.

7. The device of claim 1, the circuitry having an integrator coupled to receive the video signal to determine a value of the parameter related to brightness.

8. The device of claim 7, the circuitry comprising a line counter and a pixel counter, and comparators to compare the outputs of these counters to the row and column start and end points, outputs of the comparators being coupled to the integrator to enable it to integrate only pixel values inside the boundaries.

9. The device of claim 1, being incorporated in a handheld reader for receiving cartridges having many of the samples.

10. An image processing device (80) for determining brightness of a sample, the device having circuitry (40) arranged to receive a video signal and determine a value of a parameter related to brightness of an area (110) of one or more frames of the video in real time, and a controller (50) coupled to the circuitry to adjust boundaries of the area (110) for the circuitry, and to use the values of the parameter related to brightness for different boundaries to determine a location of one or more edges of the sample, the controller being arranged to set the boundaries according to the edges for subsequent measurements of brightness by the circuitry, and the controller being arranged to deduce a corrected brightness value for the sample from the measured brightness by compensating for a difference between a known shape of the area (110), and a shape assumed for the sample.

11. A method of using a biosensing device for sensing brightness of a sample from frames of a video signal of the bio sample, the method having the steps of;
determining a value of a parameter related to brightness of an area (110) of one or more of the frames in real time, adjusting (310, 415,440) boundaries of the area (110), using measures of brightness for different boundaries to determine (330, 430, 460) a location of one or more edges of the sample, and setting (340, 470) the boundaries according to the edges for subsequent measurements of brightness by the circuitry.

12. The method of claim 11, the determining of location of the edges involving determining a change in a relationship of brightness to area as one or more of the boundaries are changed.

13. The method of claim 11, having the step of determining a shape of the sample by setting the area (110) to be smaller than the sample, moving (415, 440) the area (110) across the sample and deducing (470) the shape from changes in the measured brightness of the area (110) as the area (110) is moved.

14. The method of claim 11, the device being incorporated in a handheld reader, and the method having the preliminary step of inserting a cartridge having the bio sample into the reader.

15. A computer program on a machine readable medium for use in a biosensing device for sensing brightness of a sample from frames of a video signal of the sample, the program being arranged to receive measurements of a parameter related to brightness of an area (110) of one or more of the frames in real time, to adjust (310, 415,440) boundaries of the area (110), and to use measures of brightness for different boundaries to determine (330, 430, 460) location of one or more edges of the sample, and to set (340, 470) the boundaries according to the edges for subsequent measurements of brightness.

16. The computer program of claim 15, further arranged to determine a shape of the sample by setting the area (110) to be smaller than the sample, move (415, 440) the area (110) across the sample and deduce (470) the shape from changes in the measured brightness of the area (110) as the area (110) is moved.
